(19) United States
(12) Patent Application Publication
(10) Pub. No.: US 2017/0140677 A1
(43) Pub. Date: May 18, 2017

(54) MARKER FOR CLOTHING

(71) Applicant: Maria Dolores IBANEZ FERNANDEZ DE LIS, Valencia (ES)

(72) Inventor: Maria Dolores IBANEZ FERNANDEZ DE LIS, Valencia (ES)

(21) Appl. No.: 15/127,610

(22) PCT Filed: Mar. 17, 2015
(86) PCT No.: PCT/ES2015/000089

§ 371 Date: Sep. 20, 2016

(30) Foreign Application Priority Data
Mar. 21, 2014 (ES) U201430374

(51) Int. Cl. G09F 3/06; G09F 3/02

(52) U.S. Cl. CPC G09F 3/06; G09F 3/02; G09F 2003/0282

(57) ABSTRACT

The invention relates to a piece that can be used for the identification, marking or decoration of objects, in particular for any type of clothing, as well as for the purpose of pairing some of these objects. The piece contains two parts sharing a common hinge, which parts are attached to one another by means of a clasp, such that the connection is preferably difficult to open once assembled. The clasp or attachment comprises a male part and a female part with a tolerance therebetween such that the piece remains clamped wherever it is to be positioned. The piece comprises rounded forms, with the minimum number of sharp edges possible, so as not to cause any discomfort once secured. The element of the piece that remains on the outside once secured can be of greater thickness and can be provided externally with suitable securing means for attaching accessories used for decoration or identification purposes, as well as screen-printed, etched or embossed patterns. The invention is intended for the decoration and textile industries.

### FIELD OF THE INVENTION

The present invention relates to a marking device for cloths intended to leave a clear and visible mark on cloths to distinguish or decorate them or to facilitate recognition of pairs among similar garments such as gloves or socks.

It can be applied at home, in laundries, restaurants, hotels, hospitals or any other institutions in which considerable volumes of similar cloths are used.

### DESCRIPTION OF RELATED ART

Marking identical or similar garments can be useful to facilitate identification. Thus, for instance, large families sometimes mark their garments with a thread to identify the owner or to rapidly classify cloths or household fabrics after washing or before setting the table.

Hospitals, hotels, restaurants or similar sites also manage large volumes of sheets, towels, serviettes and tablecloths and may occasionally need to mark them when they feature slight differences not visible to the naked eye.

It has long been practice to mark garments with a threat, which is very work-intensive, or with a special pen for fabrics. In this last case, the marking may fade or give the impression of dirtiness.

No solution to this problem similar to the present invention is known to the applicant.

### BRIEF DESCRIPTION OF THE INVENTION

The invention relates to a marking device for garments and other cloths as defined in the ‘I claim’ section.

More specifically, it refers to a marking device for cloths consisting of two elements, which may be independent, in two pieces, or may feature a common joint and a clipping fixation system between both, preferably in such a form that is difficult to open once fixed.

The clipping fixation system should feature a male and a female end, with certain tolerance between both ends so that the garment's fabric can be clamped between them. Preferably, the male end should be free from any edges to prevent wear or snags.

As previously mentioned, both pieces may be independent or may feature a common joint in the opposing edges of the male and female ends.

The first element may be thinner than the second to facilitate contact with the user's skin when applied to garments. In addition, the marking device should preferably feature rounded forms, keeping edges to a minimum.

The second element, which will normally be kept outside the cloth, may feature fixation means on the outside, opposite the female end, to fix decorative or identification elements. In addition, it can serve as anchoring point for a second marking device, which would feature a locking system capable of being connected to the fixation system.

### DESCRIPTION OF THE DRAWINGS

For an improved understanding of the invention, following drawings have been attached:

FIG. 1: View of an open marking device for cloths according to a preferred embodiment.

FIG. 2: Section of a marking device for cloths according to a variant of the invention, including the exploded view of an optional supporting element.

FIG. 3: Third example of the marking device for cloths attached to a garment, in this case a sock.

FIG. 4: View of the second element in a specific embodiment designed to allow for temporary connections between marking devices.

### DESCRIPTION OF PREFERRED EMBODIMENTS

The following examples show preferred embodiments of the invention. It is to be understood that these examples are given primarily by way of illustration and not of limitation. The drawings are not scaled and certain details have been represented bigger for convenience purposes.

The marking device described in this invention comprises a first element (1) and a second element (2), equipped with a clipping fixation system for which the first element (1) includes a male end (10) and the second element (2) includes a female end (20). The clipping fixation system shall be designed with a certain tolerance (3) so that clipping can take place from both sides of the cloth by clamping the cloth, usually in areas where the thickness of the cloth is not excessive.

Both elements (1,2) may be independent and join only after clipping or feature a common joint (4) on a shared edge, while clipping takes places on the opposite edge.

Preferably, the fist element (1) is thinner than the second one (2), for cases in which the marking device is placed on a shock or sleeve, so that the part in contact with the user's body does not excessively project beyond the cloth's edge. Furthermore, this first element—and preferably both elements—should be designed in such a way that it features rounded forms, without edges that may rub on or irritate the user's skin.

The second element (2) may feature fixation means (21) on the outside to fix through clipping or other permanent or detachable fixation systems elements for identification (letters, numbers, initials, logotypes, etc.) or decoration (shields, drawings, etc.) purposes, born by a supporting element (5) on the marking device. Such decorative elements may also be directly included on the second element (2) by engraving, painting or marking any advertising or identification element of the shop where the marking device is used.

If the supporting element (5) is fixed to the second element (2) by clipping, tolerance is not required, since no clamping will take place.

An embodiment of the marking device for cloths particularly useful for socks, gloves and other paired elements alternates the means of fixation (21) in part of the marking devices with locking devices (22) in other marking devices, so that they can be temporarily joined to match socks or gloves. An example of locking devices (22) and fixation systems (21) are the so-called automatic buttons, for which it is indifferent which is the male or the female end. When different marking devices are connected to each other, the combination should be more easily detachable that the supporting device (5) of the second element (2).

Ideally, both marking devices are identical and feature both fixation (21) and locking (22) systems, slightly displaced with respect to each other so that, when one of the marking devices is turned around and opposed to the other, both marking devices can be connected to each other (FIG. 4) in an easily detachable form.

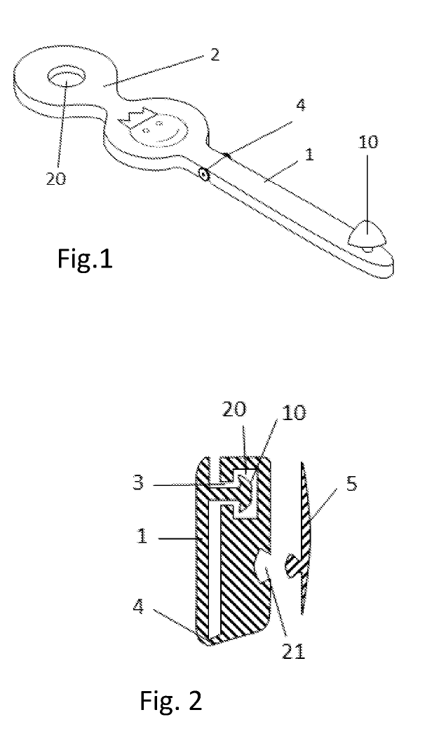

FIG. 1 shows an embodiment with a female part (20), in this case a ring, through which the male part (10)—featuring a more or less conical projection and a thinner element behind it that will match the ring's position when folded—passes. This embodiment can be disassembled by pushing the male part (10) from opposite the female part with the appropriate tools.

This embodiment includes a hinge as joint (4) and a wider part has been represented to include a decorative element. Normally, the decorative element is not visible in this view, since it is only visible from the other side, but it has been represented to illustrate its position. This element can be a shield of a sports club, a cartoon character, a brand logotype, an initial letter, the logotype of the hospital or restaurant, a code for the laundry service, any decorative object, etc.

FIG. 2 shows the section of a second embodiment in which the female part (20) is not accessible from outside to prevent it from being detached. As shown in the figure, in this case the first element (1) is considerably thinner than the second (2) and the edges have been rounded to ensure that it does not rub with the user's skin.

In this case, the joint (4) is a thinner and therefore more flexible area than the rest.

This embodiment includes means of fixation (21) for an element (5) supporting the decoration. The figure shows one means of fixation, but double means of fixation or other resources to prevent rotation are recommended.

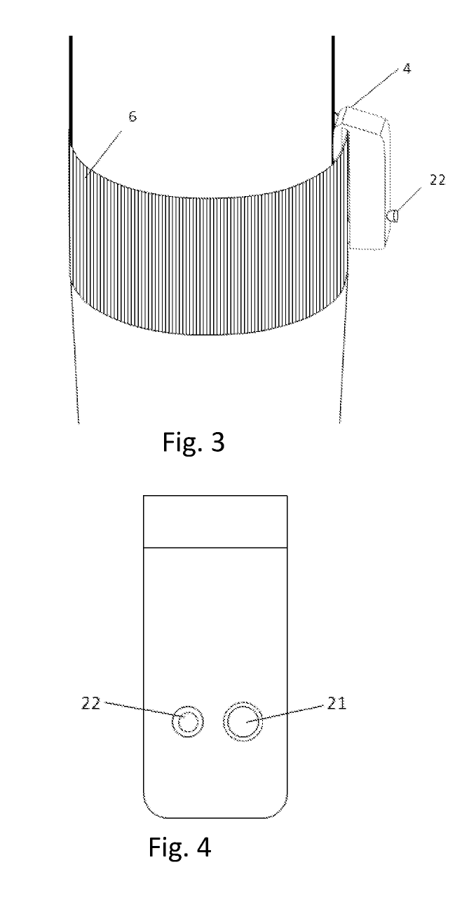

Instead of a supporting element (5), a second marking device can be attached through a locking system (22) to pair marked garments. An example of this second marking device is shown in FIG. 3, where it is fixed to the upper part of a sock (6), which is usually reinforced.

It is indeed equally possible to include supporting elements (5) capable of being attached to the locking systems (22).

Marking devices can be designed in different materials and colors, being plastic the preferred material for price reasons, usually polyethylene. They can be sold in sets of one or various colors, preferably including an even number of units in each color to mark paired garments, such as gloves or socks.

1. A marking device for cloths characterized by a first element (1) with a male part (10) and a second element (2) with a female part (20), so that the male part can be fixed by clipping to the female part with tolerance (3) suitable for cloths.

2. A marking device according to claim 1, characterized by featuring a joint (4) joining the first element (1) with the second element (2) on the opposite edge to the female and male ends.

3. A marking device according to claim 1, characterized by featuring fixation means (21) on the outside of the second element (2).

4. A marking device according to claim 3, characterized by featuring a supporting device (5) for decorative or identification elements attached to the means of fixation (21).

5. A marking device according to claim 1, characterized by featuring locking means (22) capable of being connected to the fixation means (21) described in claim 3.

6. A marking device according to claim 1, characterized by the fact that the first element (1) is thinner than the second element (2).

7. A marking device according to claim 1, characterized by featuring a rounded form.
